(19) United States
(12) Patent Application Publication
(10) Pub. No.: US 2011/0208813 A1
(43) Pub. Date: Aug. 25, 2011

(54) Personal status communications manager

(75) Inventors: John Storrie, Maidenhead (GB); Michael Mentz, Perivale (GB); Paul Skidmore, Maidenhead (GB); Lydia Chung, Bray (GB)

(73) Assignee: NORTEL NETWORKS LIMITED, St. Laurent (CA)

(21) Appl. No.: 12/458,108

(22) Filed: Jun. 30, 2009

(51) Int. Cl. G06F 15/16

(52) U.S. Cl. 709/204

(57) ABSTRACT

A user status may be updated at one of a plurality of network entities associated with a user. Through communication between the network entity on which the update has been made and a central server, an indication of the status update may be transmitted, by the central server, to the other network entities associated with the user.

### FIELD OF THE INVENTION

The present application relates generally to office communications management and, more specifically, to a personal status communications manager.

### BACKGROUND OF THE INVENTION

Within the area of personal communications management, users of personal communications management applications often find it useful to indicate a level of availability.

A given user may be associated with a wide range of network entities, each of the network entities associated with a mode of communication and operable to indicate a level of availability of the user.

### SUMMARY

A user status may be updated at one of a plurality of network entities associated with a user. Through communication between the network entity on which the update has been made and a central server, an indication of the status update may be transmitted, by the central server, to the other network entities associated with the user.

In accordance with an aspect of the present invention there is provided a method of facilitating automatic replication of a user status associated with one mode of communication among a plurality of modes of communication, the replication accomplished across a plurality of network entities of the plurality of modes of communication. The method including receiving indication of an occurrence of a trigger event representative of a change in the user status associated with the one mode of communication, selecting, based on the trigger event, an instruction associated with a network entity associated with a given mode of communication among the plurality of modes of communication and transmitting, to the network entity, the instruction, thereby allowing the network entity to represent the user status in a manner suitable for the network entity. In other aspects of the present invention, an apparatus is provided for carrying out this method and a computer readable medium is provided for adapting an apparatus to carry out this method.

Other aspects and features of the present invention will become apparent to those of ordinary skill in the art upon review of the following description of specific embodiments of the invention in conjunction with the accompanying figures.

### BRIEF DESCRIPTION OF THE DRAWINGS

Reference will now be made to the drawings, which show by way of example, embodiments of the invention, and in which:

FIG. 1 illustrates a network environment in which aspects of the present disclosure are applicable;

FIG. 2 illustrates a structure for a user profile for use in aspects of the present application;

FIG. 3 illustrates an example of a user profile having the structure presented in FIG. 2; and

FIG. 4 illustrates example steps in a method of facilitating automatic replication of a user status according to an aspect of the present application.

### DETAILED DESCRIPTION OF THE EMBODIMENTS

Within many calendar applications there is the ability to set up an out of office notification that applies to the email system that the user has as their preferred email system.

Prior to this invention it is not possible to accurately reflect a user's out of office status on all of their endpoints as co-ordination of those endpoints and their management was not consistent.

This lead to the problem that a user had to hand manage individual network entities using explicit proprietary command sequences for that network entity.

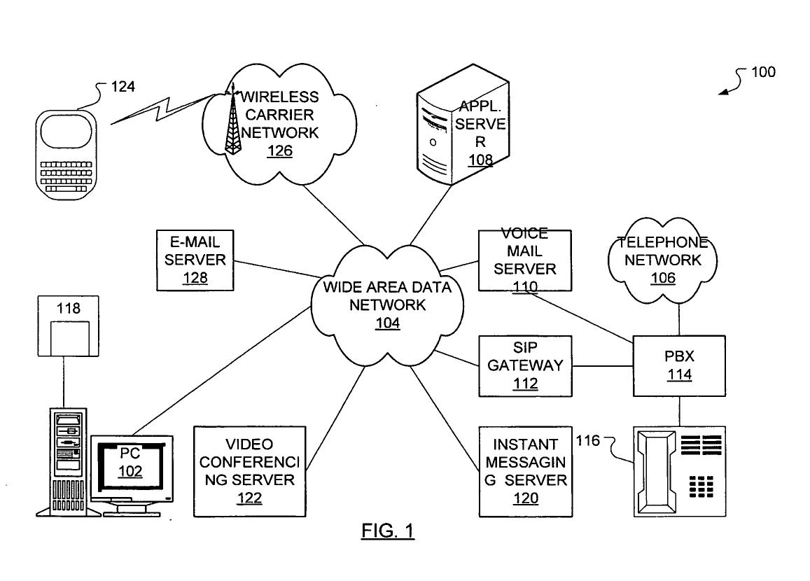

FIG. 1 illustrates a network environment 100 in which aspects of the present disclosure are applicable, and in which may be found an application server 108 is connected to a wide area data network 104, such as today's Internet or one of its successor networks. As is common, the application server 108 may incorporate a processor and associate long-term and short-term memory (not shown).

Also connected to the wide area data network 104 is a Private Branch Exchange (PBX) 114. The PBX 114 may be additionally connected to a telephone network 106. It will be understood that many telephones may be connected to the PBX 114, however, only one example telephone 116 is illustrated in FIG. 1 as being connected to the PBX 114 for desktop telephony. Also connected to the PBX 114 is a voice mail server 110 for performing voicemail services, such as receiving, storing and providing voicemail messages. Notably, the voice mail server 110 may also be connected to the wide area data network 104.

One or more client applications may be executed by a personal computer (PC) 102, which is illustrated communicatively connected to the wide area data network 104. Memory (not shown) in the first PC 102 may be loaded with software for executing aspects of the present disclosure from a software medium 118 which could be a disk, a tape, a chip or a random access memory containing a file downloaded from a remote source.

Other communication equipment may also form a portion of the network environment 100 of FIG. 1. An e-mail server 128 is illustrated connected to the wide area data network 104. An instant messaging server 120 is also illustrated connected to the wide area data network 104. Additionally, a video conferencing server 122 is illustrated connected to the wide area data network 104. As should be clear to a person of ordinary skill in the art, it is often the case that instant messaging and video conferencing are handled, at the endpoints, by a single application and, at the midpoint, by a single server.

The network environment 100 of FIG. 1 is also illustrated as including a mobile communication device 124 connected to a wireless carrier network 126. The wireless carrier network 126 may include a base station subsystem (not shown) and a wireless network subsystem (not shown). A base station antenna, with which the mobile communication device 124 may communicate wirelessly, is provided as part of the base station subsystem. The base station subsystem connects to a wireless network subsystem (not shown). The wireless network subsystem, which may include, in part, a Mobile-services Switching Center (MSC, not shown), is connected to the wide area data communication network 104.

To summarize FIG. 1, the PC 102, the telephone 116 and the mobile communication device 124 may be considered to be network entities associated with a single user. The application server 108, the voice mail server 110, the instant messaging server 120, the e-mail server 128 and the video conferencing server 122 may be considered providers of modes of communication to the user.

Users of Microsoft Outlook™ in conjunction with Microsoft Exchange™ Server may be familiar with an Out of Office assistant that arranges automated transmission of a preset response to messages received at a user's e-mail inbox. The preset response may be edited by the user to indicate that the user will be away from the office and out of e-mail contact for a predetermined amount of time.

Similarly, with a voice mail system, a user may select among a regular outgoing greeting and a vacation greeting. The vacation greeting indicate that the user will be away from the office and out of touch with the voice mail server for a predetermined amount of time.

Furthermore, instant messaging applications have developed more finely grained status indications. A user of an instant messaging application may set status to: Online; Busy; Be Right Back; Away; On The Phone; Out To Lunch; or Appear Offline.

In overview, aspects of the present disclosure, the user may indicate a status to a single one of the providers of modes of communication. Subsequently, the status may be distributed to all of the providers of modes of communication associated with the user.

To facilitate co-ordination and distribution of user status updates by the application server 108, the user creates and edits a user profile. Such creation and editing may be accomplished by the user with a client application executed on the PC 102. The client application may communicate, over the wide area network 104, with a personal status communications manager application executed on the processor of the application server 108. Alternatively, a user profile may be created and edited by an administrator.

A user profile may be configured to associate the user with network entities and modes of communication. The user profile may define a trigger event and associate with the trigger event handling rules that specify actions to be carried out by the servers of the modes of communications.

The orchestration is an internal application construct that is intelligent enough to understand how the incoming event is to be handled based upon a series of user generated handling rules. These rules take the incoming event, the OOO alert with the associated OOO information, and begins the process of setting up the required alerts.

For example, the voice mail system is identified from the user profile and the incoming user OOO greeting is converted to the relevant format necessary for the voice mail system to re-play the greeting to callers, and the user's network entities is then set up to forward to the voice mail system when any caller terminates on that network entity. The orchestration engine will issue the relevant signaling and media control sequences to effect that forwarding activity and this may well be very different for each voice mail system and network entity.

The users instant message system is identified from the profile and is then sent the relevant control and media signaling to set up the required notification for the OOO alert.

This sequence of control and media signaling is repeated for each of the relevant devices or network entities in the user profile that is associated with handling the OOO alert and each network entity may require very different handling and this is transparent to the user.

The user now can automatically update multiple environments without having to individually update those network entities one by one.

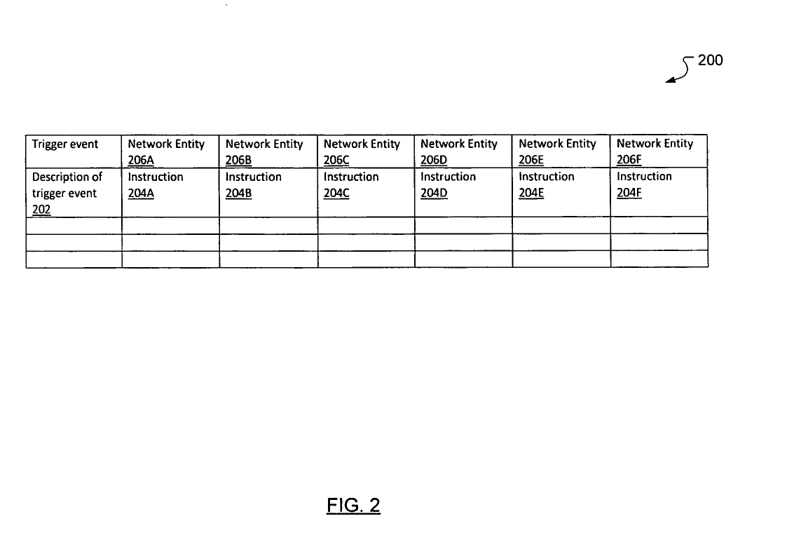

FIG. 2 illustrates a structure 200 for a user profile for use in aspects of the present application. The user profile structure includes an description 202 of a trigger event. For each of a plurality of network entities 206A, 206B, 206C, 206D, 206E, 206F (collectively or individually 206) associated with the user and with various modes of communication, the user profile structure 200 includes an instruction 204A, 204B, 204C, 204D, 204E, 204F (collectively or individually 204), respectively.

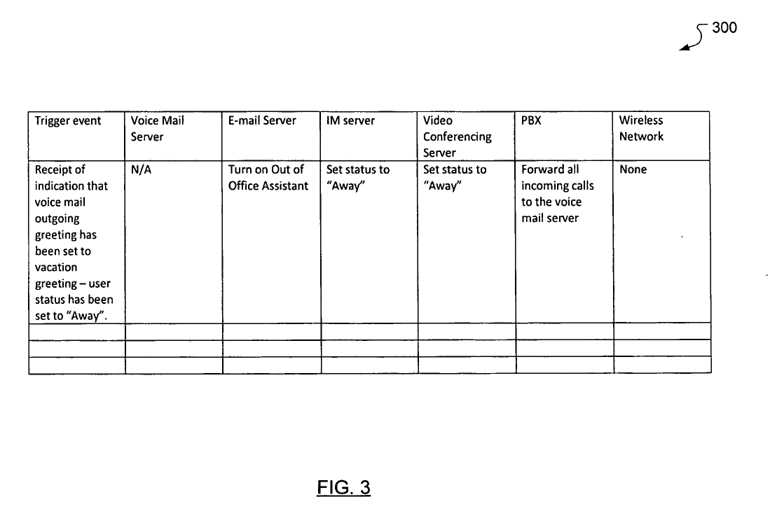

FIG. 3 illustrates an example 300 of a user profile having the structure 200 presented in FIG. 2.

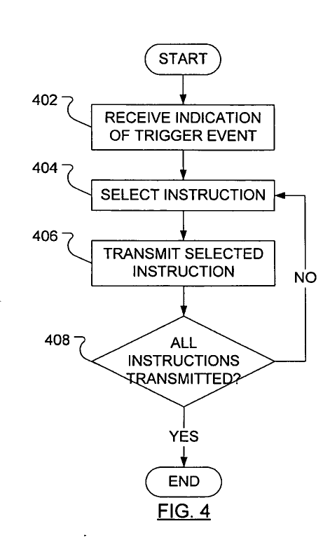

FIG. 4 illustrates example steps in a method, carried out by the processor of the application server 108, of facilitating automatic replication of a user status. Initially, processor of the application server 108, under control of the personal status communications manager application, receives (step 402), from a network entity associated with the user and with a mode of communication, an indication of the occurrence of the event. The personal status communications manager recognizes the event as a “trigger event”. Trigger events may, for instance, be representative of a change in user status associated with one mode of communication.

Responsive to receiving (step 402), from the network entity, the indication of the event, the personal status communications manager selects (step 404), based on the trigger event (202, FIG. 2), an instruction 204 associated with a network entity 206 associated with a given mode of communication among the plurality of modes of communication.

The application server 108 may include a “rules engine” to extract, from a user profile, behavioral rules that associate trigger events with instructions for network entities. When performing the selection of step 404, the personal status communications manager may simply select the instructions 204 in the order in which the instructions 204 appear in the user profile.

Subsequent to selecting (step 404) an instruction from the user profile, the application server transmits (step 406) the selected instruction 204 to the associated network entity 206. The network entity, upon receipt of the instruction, carries out the instruction.

As will be clear to a person of ordinary skill in the art, the application server 108 may be configured with protocols and signaling schemes appropriate for communication with each of the network entities with which the application server 108 will be expected to communicate.

Subsequent to transmitting (step 406) the instruction, the personal status communications manager determines (step 408) whether any further instructions remain to be transmitted, according to the user profile 200. Upon determining (step 408) that further instructions remain to be sent, the personal status communications manager returns to the selecting step to select (step 404) a further instruction and transmit (step 406) the transmitted instruction.

Consider a scenario in which the user uses the telephone 116 to connect to the voice mail server 110 via the PBX 114. The user interacts with an interface presented by the voice mail server 110 and indicates a desire to record an out of office outgoing greeting. The user may, for example, record a outgoing greeting that says “I am out of the office. I plan to return to the office on the 10^{th}.” Upon completion of interaction with the voice mail server 110, the user hangs up the telephone 116. Responsive to the occurrence of a recognized event, i.e., the setting of the out of office greeting, the voice mail server 110 transmits an indication of the event to the application server 108.

Turning to FIG. 4, the personal status communications manager receives (step 402), from the voice mail server 110, the indication of the occurrence of the event. The personal status communications manager recognizes the event, i.e., the setting of the out of office voice mail greeting, as a “trigger event” for which a description 302 exists in the user profile 300.

Responsive to receiving (step 402), from the voice mail server 110, the indication of the event, the personal status communications manager selects (step 404), based on the trigger event, an instruction associated with a network entity associated with a given mode of communication among the plurality of modes of communication. Recall that the user profile 300 of FIG. 3 associates a distinct instruction with each of five distinct network entities.

For example, the personal status communications manager may select (step 404), based on the setting of the out of office voice mail greeting trigger event, the instruction associated with the e-mail server 128. Upon selecting (step 404) the instruction associated with the e-mail server 128, the personal status communications manager may then transmit (step 406), to the e-mail server 128, an instruction to turn on out of office assistant.

It could be that the voice mail server 110 is equipped with speech-to-text conversion software. Accordingly, when indicating to the application server 108 that the out of office voice mail greeting trigger event has occurred, the voice mail server may also indicate that the outgoing message has been set as “I am out of the office. I plan to return to the office on the 10^{th}.” Given an appropriate protocol, the personal status communications manager, when transmitting (step 406), to the e-mail server 128, the instruction to turn on out of office assistant may, as part of the instruction, indicate that the out of office greeting should read “I am out of the office. I plan to return to the office on the 10^{th}.”

Alternatively, the voice mail server 110 could transmit, to the application server 108, a digital representation of the audio of the outgoing out of office greeting. Then, the application server 108 could perhaps perform speech-to-text conversion on the audio and, as part of the instruction to the e-mail server 128, indicate that the out of office greeting should read “I am out of the office. I plan to return to the office on the 10^{th}.”

Upon determining (step 408) that further instructions remain to be transmitted, the personal status communications manager may select (step 404) the instruction associated with the IM server 120. The personal status communications manager may then transmit (step 406), to the IM server 120, a message instructing the IM server 120 to change the indication of the status of the user to “Away”.

Such selecting (step 404) and transmitting (step 406) may continue until the personal status communications manager determines (step 408) that no more instructions associated with the trigger event remain to be sent. Responsively, the method may be considered to be complete.

Advantageously, the user is able to update status on a single network entity and the status of the user, as presented by each of the user's associated network entities, is updated. Conveniently, the network entity on which the status update is set need not understand signaling and control requirements specific to each of the other network entities.

The associated network entities are managed for the user, with relevant proprietary command sequences sent to the network entities to effect the change of state and provide the relevant notification to users of the mode of communication associated with that network entity.

The above-described embodiments of the present application are intended to be examples only. Alterations, modifications and variations may be effected to the particular embodiments by those skilled in the art without departing from the scope of the application, which is defined by the claims appended hereto.

What is claimed is:

1. A method of facilitating automatic replication of a user status associated with one mode of communication among a plurality of modes of communication, said replication accomplished across a plurality of network entities of said plurality of modes of communication, said method comprising:
receiving indication of an occurrence of a trigger event representative of a change in said user status associated with said one mode of communication;
selecting, based on said trigger event, an instruction associated with a network entity associated with a given mode of communication among said plurality of modes of communication; and
transmitting, to said network entity, said instruction, thereby allowing said network entity to represent said user status in a manner suitable for said network entity.

2. The method of claim 1, wherein said user status comprises an out of office status.

3. The method of claim 1, wherein said plurality of modes of communication includes voice mail.

4. The method of claim 1, wherein said plurality of modes of communication includes desktop telephony.

5. The method of claim 1, wherein said plurality of modes of communication includes mobile telephony.

6. The method of claim 1, wherein said plurality of modes of communication includes instant messaging.

7. The method of claim 1, wherein said plurality of modes of communication includes video conferencing.

8. The method of claim 1 further comprising storing a user profile, wherein said user profile includes an association between said trigger event, said network entity and said instruction.

9. An application server including a processor configured to execute a personal status communications manager application to:
receive an indication of an occurrence of a trigger event representative of a change in a user status associated with one mode of communication among a plurality of modes of communication;
select, based on said trigger event, an instruction associated with a network entity associated with a given mode of communication among said plurality of modes of communication; and
transmit, to said network entity, said instruction, thereby allowing said network entity to represent said user status in a manner suitable for said network entity.

10. A computer readable medium containing computer-executable instructions that, when performed by a processor in an application server, cause said processor to:
receive an indication of an occurrence of a trigger event representative of a change in a user status associated with one mode of communication among a plurality of modes of communication;
select, based on said trigger event, an instruction associated with a network entity associated with a given mode of communication among said plurality of modes of communication; and
transmit, to said network entity, said instruction, thereby allowing said network entity to represent said user status in a manner suitable for said network entity.
